(19) United States
(12) Patent Application Publication
(10) Pub. No.: US 2014/0105116 A1
(43) Pub. Date: Apr. 17, 2014

(54) Method and Apparatus for Exchanging Wireless Network Management Message

(71) Applicant: Huawei Device Co., Ltd., Shenzhen (CN)

(72) Inventors: Zhiming Ding, Shenzhen (CN); Kecheng Yu, Shenzhen (CN); Xiandong Dong, Shenzhen (CN)

(73) Assignee: Huawei Device Co., Ltd., Shenzhen (CN)

(21) Appl. No.: 14/138,358

(22) Filed: Dec. 23, 2013

Related U.S. Application Data
(63) Continuation of application No. PCT/CN2012/078703, filed on Jul. 16, 2012.

(30) Foreign Application Priority Data
Jul. 15, 2011 (CN) 201110199408.2

(51) Int. Cl. H04W 74/06

(52) U.S. Cl. CPC H04W 74/06
USPC 370/328

(57) ABSTRACT

A method for exchanging a wireless network management message includes: an access point device receives a terminal management message sent by a terminal, and in a contention-free period, sends a management polling frame to the terminal. After receiving, in a contention-free period, the management polling frame sent by the access point device, the terminal sends a next terminal management message to the access point device. The embodiments of the present invention further provide an access point device and a terminal for exchange a wireless network management message. Because the access point device controls the terminal to send a wireless network management message in a contention-free period, a problem of a conflict in a contention period among a plurality of terminals that have accessed a network is avoided, thereby decreasing time for a terminal to access a network.

### CROSS-REFERENCE TO RELATED APPLICATIONS

This application is a continuation of International Application No. PCT/CN2012/078703, filed on Jul. 16, 2012, which claims priority to Chinese Patent Application No. 201110199408.2, filed with the Chinese Patent Office on Jul. 15, 2011, both of which are incorporated herein by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The embodiments of the present invention relate to the field of wireless communications technologies, and in particular, to a method and an apparatus for exchanging a wireless network management message.

### BACKGROUND

In a process of accessing a wireless communications network, especially a wireless fidelity (Wi-Fi) network, a terminal exchanges, with an access point, in a contention period, a series of management messages related to accessing the network. An access point device may be a base station, and may also be an Access Point (AP) (e.g., a wireless access point). After a terminal accesses a network, in some circumstances, the terminal may also exchange a series of management messages with an access point device so as to implement a certain function, for example, updating a key. These management messages are all sent in a contention period. In a contention period, to avoid a conflict, a terminal waits for a period of time in a random backoff manner before sending a management message, and then sends the management message after backoff time expires. In a backoff timing process, a case that a channel is idle and no terminal uses the channel occurs, thereby causing channel resource waste. When a large number of terminals send management messages to an access point in a contention period, a probability that a conflict occurs may greatly increase. After a conflict occurs, backoff time that a terminal takes is increased so as to decrease a conflict probability. It is possible that a terminal successfully sends a to-be-sent management message after a plurality of conflicts occur, thereby causing problems of delay, channel resource waste, and message exchange with low efficiency.

### SUMMARY

Embodiments of the present invention provide a method and an apparatus for exchanging a wireless network management message, so as to avoid problems of channel resource waste and message exchange with low efficiency that arise when an access point simultaneously exchanges management messages with a large number of terminals.

Objectives of the present invention are achieved by using the following technical solutions:

A method for exchanging a wireless network management message includes: receiving a first terminal management message sent by a terminal; and sending a management polling frame to the terminal in a contention-free period, so that the terminal sends a second terminal management message according to the management polling frame.

A method for exchanging a wireless network management message includes: sending a terminal management message to an access point device; receiving, in a contention-free period, a management polling frame sent by the access point device; and sending a second terminal management message to the access point device after receiving the management polling frame.

An access point device includes: a terminal management message receiving module configured to receive a first terminal management message sent by a terminal; and a polling triggering module configured to send a management polling frame to the terminal in a contention-free period, so that the terminal sends a second terminal management message according to the management polling frame.

A terminal includes: a terminal management message sending module configured to send a first terminal management message to an access point device; and a polling frame receiving module configured to receive, in a contention-free period, a management polling frame sent by the access point device, where the terminal management message sending module is further configured to send a second terminal management message to the access point device after the polling frame receiving module receives the management polling frame.

It can be seen from the technical solutions provided in the embodiments of the present invention that, in the embodiments of the present invention, an access point device controls a terminal to send a wireless network management message in a contention-free period, which avoids a problem of a conflict between terminals caused by a fact that the access point device simultaneously exchanges management messages with a plurality of terminals in a contention period, thereby decreasing time for exchanging a management message. In addition, the terminal sends a management message in a contention-free period, thereby increasing a utilization rate of a channel.

### BRIEF DESCRIPTION OF THE DRAWINGS

To describe the technical solutions in the embodiments of the present invention more clearly, the following briefly describes the accompanying drawings required for describing the embodiments. The accompanying drawings in the following description show only some embodiments of the present invention, and persons of ordinary skill in the art may also derive other drawings from these accompanying drawings without creative efforts.

FIG. 1 is a flowchart of a method on an access point device side according to an embodiment of the present invention;

FIG. 2 is a flowchart of a method on a terminal side according to an embodiment of the present invention;

FIG. 3 is a flowchart of a method according to an application embodiment of the present invention;

FIG. 4 is a schematic diagram of polling according to another application embodiment of the present invention;

FIG. 5 is a schematic structural diagram of an access point device according to an embodiment of the present invention; and

FIG. 6 is a schematic structural diagram of a terminal according to an embodiment of the present invention.

### DETAILED DESCRIPTION

The following clearly describes the technical solutions in the embodiments of the present invention with reference to the accompanying drawings in the embodiments of the present invention. The embodiments to be described are only a part rather than all of the embodiments of the present invention. All other embodiments obtained by persons of ordinary skill in the art based on the embodiments of the present invention without creative efforts shall fall within the protection scope of the present invention.

The present invention provides a method for exchanging a wireless network management message in a wireless communications network.

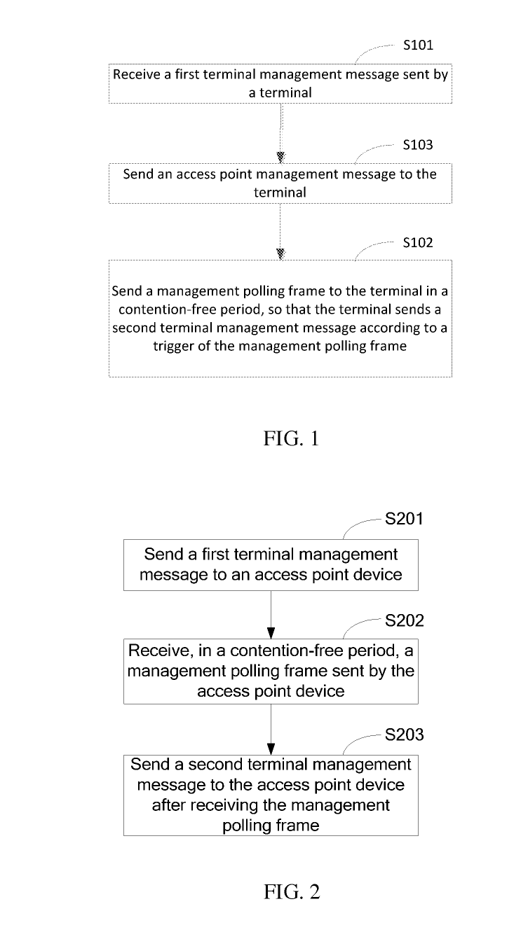

On an access point device side, an implementation manner for exchanging a wireless network management message, as shown in FIG. 1, specifically includes the following operations.

S101: Receive a first terminal management message sent by a terminal.

In a process that the terminal accesses a network, the terminal management message refers to a network accessing message sent by the terminal to an access point device, such as a series of network accessing messages stipulated in the Institute of Electrical and Electronics Engineers (IEEE) 802.11 protocol; and after the terminal accesses the network, when the terminal exchanges with an access point to implement a certain function (for example, updating a key), the terminal management message refers to a series of service requesting messages sent by the terminal to the access point to implement the function.

S102: Send a management polling frame to the terminal in a contention-free period, so that the terminal sends a second terminal management message according to a trigger of the management polling frame.

The management polling frame is a type of management frame, and is used to perform polling on the terminal in a process that the access point device exchanges a management message with the terminal, so as to trigger the terminal to send a second terminal management message. As an example rather than a limitation, a difference between the management polling frame in the embodiment of the present invention and a polling frame in the prior art lies in that: the management polling frame includes triggering information but does not include data information.

On a terminal side, an implementation manner for exchanging a wireless network management message, as shown in FIG. 2, specifically includes the following operations.

S201: Send a first terminal management message to an access point device.

S202: Receive, in a contention-free period, a management polling frame sent by the access point device.

S203: Send a second terminal management message to the access point device after receiving the management polling frame.

With the method for exchanging a wireless network management message provided in the embodiment of the present invention, an access point device sends a management polling frame to a terminal, so as to control the terminal to send a terminal management message in a contention-free period. Therefore, a problem of a conflict among a plurality of terminals in a contention period is avoided, thereby decreasing time for exchanging a management message. In addition, a wireless network management message is sent in a contention-free period, thereby increasing a utilization rate of a channel.

In the method provided in the embodiment of the present invention, between step S101 and step S102, a step S103 may further be included: send an access point management message to the terminal, where the access point management message carries contention-free instruction information, and the contention-free instruction information is used for instructing the terminal to receive the management polling frame in the contention-free period.

The access point management message refers to a response message that corresponds to the terminal management message and is returned by the access point device to the terminal.

The contention-free instruction information may specifically be a flag bit. The contention-free instruction information may further include polling time information, so that the terminal waits for receiving a management polling frame at a moment of a contention-free period specified by the polling time information.

In the method provided in the embodiment of the present invention, the terminal management message sent by the terminal may further carry information about quality of service. As an example rather than a limitation, in a process that the terminal accesses a network, the information about quality of service includes: information about a maximum duration for completing a network accessing process, information about a network accessing priority, and the like. A preferable rule of a network accessing priority is exemplified: when a terminal performs a network handover, such as, a handover from a 3rd generation partnership project (3GPP) network to a Wi-Fi network, a seamless handover is required, and a priority is high; and when the terminal initially accesses a network when being powered on, it only needs to arrange proper time for accessing the network, and a priority is low. After the terminal accesses the network, in a process that the terminal exchanges a management message with an access point device to implement a certain function, the information about quality of service may be a requirement of quality of service of the terminal, which is not limited herein.

If the terminal management message carries the information about quality of service, before the access point management message is returned to the terminal in step S103, the method provided in the embodiment of the present invention further includes: determining polling time for the terminal according to the information about quality of service that is carried in the terminal management message. The access point device may receive terminal management messages of a plurality of terminals; in addition, it is also possible that a terminal that has accessed the network needs to perform data transmission. Therefore, when polling time is determined for a terminal, it needs to consider information about quality of service of each terminal that exchanges a management message, a requirement of quality of service of a transport stream that is established by a terminal that has accessed the network, and the like, so as to determine the polling time for the terminal.

In an embodiment, the terminal enters a dormant state after the terminal receives the access point management message and before the polling time arrives. The following describes a specific implementation manner of an embodiment of the present invention in an actual application process in detail.

In a current wireless communications network, a time axis is divided into continuous Beacon periods, and each Beacon period is further divided into two parts: an active period and inactive period. The active period is further divided into a contention-free period and a contention period; a duration of a contention-free period may be controlled by an access point device, and in the contention-free period, a polling mechanism is adopted, and the access point device assigns, through polling, a bandwidth to each terminal that has accessed a network, so that the terminal may upload a transport stream; the access point device ends the contention-free period through a contention free end (CF-END) signal and enters a contention period; and in the contention period, each terminal that has accessed the network needs to establish a wireless initial connection with the access point device by sending a series of network accessing messages, and a terminal that has accessed the network exchanges a series of management messages with the access point device to implement a certain management function. In an inactive period, a terminal switches to a power-saving mode and enters a dormant state.

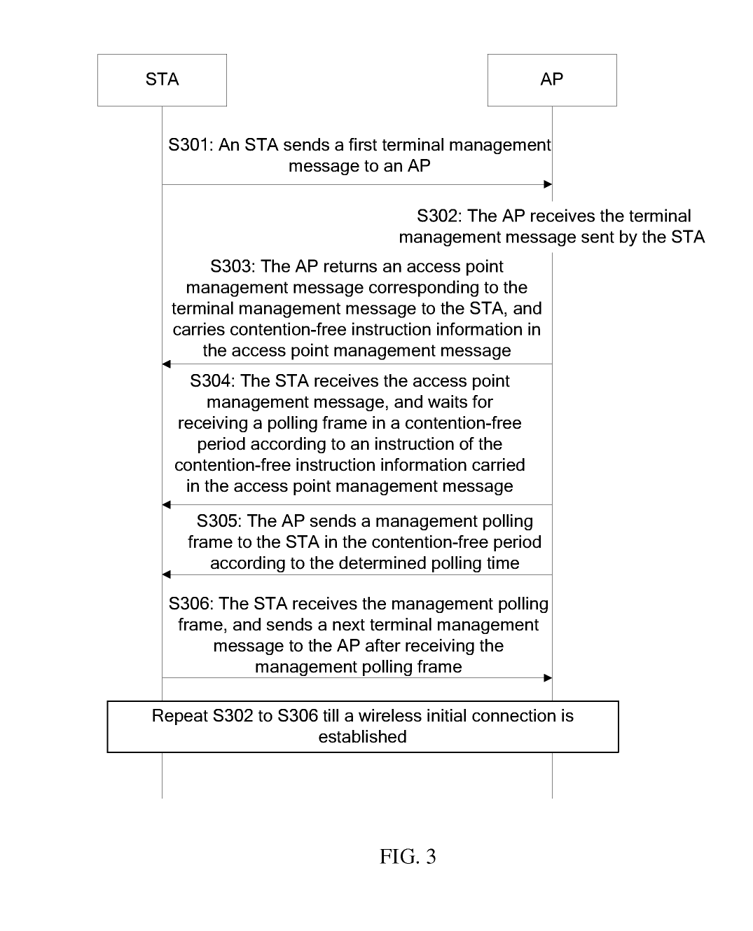

In an application embodiment provided in the present invention, a terminal is handed over from a 3GPP network to a Wi-Fi network. In a Wi-Fi network, a terminal is called a station (STA). In a handover process, a process that the STA establishes a wireless initial connection with a wireless AP in the Wi-Fi network, as shown in FIG. 3, specifically includes the following operations.

S301: An STA sends a first terminal management message to an AP in a network accessing process.

The terminal management message may carry information about quality of service.

As an example rather than a limitation, the first terminal management message may be a unicast Probe-request (e.g., a probe request frame) or an Authentication-request (e.g., an authentication request frame).

According to an existing communications standard, the first terminal management message is sent in a contention period.

S302: The AP receives the terminal management message sent by the STA.

S303: The AP returns an access point management message corresponding to the terminal management message to the STA, and carries contention-free instruction information in the access point management message.

The contention-free instruction information may be a flag bit, which indicates that the AP may perform polling on the STA in a subsequent contention-free period; and the contention-free instruction information may further include polling time information to instruct the STA to start to prepare for receiving, at the moment of a contention-free period specified by the polling time information, a management polling frame sent by the AP, and send a next terminal management message after receiving the management polling frame, where the polling time is a time point within the contention-free period. The AP may determine polling time for the STA according to parameters such as the information about quality of service carried in the terminal management message, information about quality of service sent by another STA that performs management message exchange, a requirement for quality of service of a transport stream established by an STA that has accessed a network, and channel quality, and generate contention-free instruction information according to the determined polling time.

If the terminal management message is a unicast probe request frame, the access point management message is a probe response frame; and if the terminal management message is an authentication request frame, the access point management message is an authentication response frame.

S304: The STA receives the access point management message, and waits for receiving a polling frame in a contention-free period according to an instruction of the contention-free instruction information carried in the access point management message.

If the contention-free instruction information includes polling time information, the STA specifically starts to wait for receiving a polling frame at a moment of a contention-free period specified in the polling time information; and if the contention-free instruction information does not include polling time information, the STA starts to wait for receiving a polling frame when a contention-free period starts.

Optionally, the STA enters a dormant state after receiving the access point management message, and waits for receiving a management polling frame until a contention-free period starts or a specified polling time arrives.

S305: The AP sends a management polling frame to the STA in the contention-free period according to the determined polling time.

S306: The STA receives the management polling frame, and sends a next terminal management message to the AP after receiving the management polling frame.

In this embodiment, if the first terminal management message is a probe request frame, a second terminal management message is an authentication request frame; if the first terminal management message is an authentication request frame, a second terminal management message may be an association request frame; and a process of exchanging a management message in a process of establishing a Wi-Fi initial connection belongs to the prior art, and these management messages are not listed one by one herein.

Repeat S302 to S306 till a wireless initial connection is established.

By using the method according to the present invention, in the embodiment, except that the first terminal management message is sent in a contention period and the first access point management message is received in the contention period, a subsequent terminal management message may be sent in a contention-free period under an instruction of the AP, and a subsequent access point management message is received in the contention-free period. However, if the STA accidentally misses receiving the management polling frame sent by the AP, which causes that the STA cannot send a subsequent terminal management message in an instructed contention-free period, the STA may still send a subsequent terminal management message in a contention period.

If a last management message for establishing a wireless initial connection is sent by the AP, the AP does not need to carry contention-free instruction information in the access point management message that is returned to the STA.

In the application embodiment, that an STA establishes a wireless initial connection when being handed over to a Wi-Fi network is taken as an example to describe the method for exchanging a wireless network management message provided in the embodiment of the present invention in detail. In another application scenario, for example, after an STA accesses a network and when a key is updated, for a process of exchanging a wireless network management message, reference may be made to the foregoing processing process, which is not described herein again.

In a method for establishing a wireless initial connection provided in another application embodiment of the present invention, an AP controls each STA that needs to access a network to send, in a contention-free period as possible as an STA can, a terminal management message for accessing a network, and specifically triggers each STA to send a terminal management message by using a polling mechanism.

Assuming that three STAs need to establish a wireless initial connection with an AP, the three STAs send first terminal management messages to the AP in the same contention period. An STA 1 and an STA 2 are handed over from a 3GPP network to a Wi-Fi network, and the STA 1 sends a first terminal management message to the AP before the STA 2; and an STA 3 initially accesses a Wi-Fi network when being powered on.

The first terminal management messages sent by the three STAs carry information about quality of service, where the information about quality of service includes: information about a maximum duration for completing a network accessing process and information about a network accessing priority. After receiving the first terminal management messages sent by the three STAs, the AP arranges and determines polling time for the three STAs according to a network accessing priority and a maximum duration of a network accessing process of each STA, and generates a polling queue, so that polling is performed on the three STAs when a contention-free period arrives. Network accessing priorities of the STA 1 and the STA 2 are higher than that of the STA 3, and the STA 1 sends the first terminal management message before the STA 2. Therefore, a sequence of network accessing priorities from high to low is: the STA 1, the STA 2, and the STA 3. According to the network accessing priorities, a sequence that the AP performs polling is: the STA 1, the STA 2, and the STA 3, that is, the sequence that the AP performs polling may be arranged according to the network accessing priorities from high to low.

For the first terminal management messages sent by the three STAs, the AP generates access point management messages and carries contention-free instruction information in each access point management message; notifies, by using the contention-free instruction information, a corresponding STA to wait for polling in a specified contention-free period; and sends the access point management messages to the three STAs.

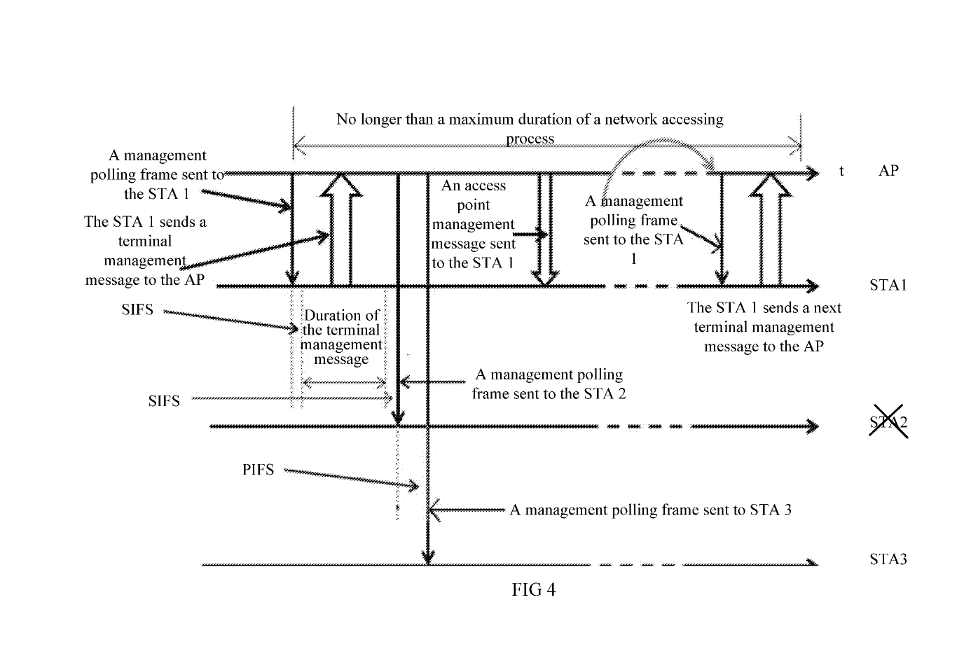

In the specified contention-free period, the AP performs polling on the three STAs, according to the polling queue, a polling process of which is as shown in FIG. 4: when the polling time determined for the STA 1 arrives, the AP sends a management polling frame to the STA 1; after receiving the management polling frame sent by the AP, the STA 1 sends a next terminal management message to the AP after waiting for one Short Interframe Space (SIFS), where the terminal management message carries information about a network accessing priority; after receiving the next terminal management message sent by the STA 1, the AP sends a management polling frame to the STA 2 after waiting for one SIFS; if the AP fails to receive a next terminal management message sent by the STA 2, the AP no longer repeats polling on the STA 2 but starts to time since a management polling frame is sent to the STA 2, and sends a management polling frame to the STA 3 after waiting for one Point Coordination Function (PCF) Interframe Space (PIFS); after receiving the management polling frame sent by the AP, the STA 3 sends a next terminal management message to the AP after waiting for one SIFS, where the terminal management message carries information about a network accessing priority; and after receiving the next terminal management messages sent by the STA 1 and the STA 3, the AP separately processes the terminal management messages sent by the STA 1 and the STA 2, generates access point management messages, and separately returns the access point management messages to the STA 1 and the STA 3 at a proper moment, where the access point management messages carry contention-free instruction information. The proper moment refers to a moment that is determined by the AP according to parameters such as channel quality and a maximum duration for a network accessing process of an STA.

If the AP fails to receive the next terminal management message sent by the STA 2, the AP does not return a corresponding access point management message to the STA 2, that is, the STA 2 misses polling in this round. Then, the STA 2 may continue to send a terminal management message in a next contention period.

Repeat the foregoing process till a wireless initial connection is established.

A process of establishing a wireless initial connection may be accomplished in a plurality of Beacon periods (as shown by a dashed line in FIG. 4). However, accumulated time for the process of establishing a wireless initial connection should be controlled within a range of a maximum duration of a network accessing process, where the maximum duration of the network accessing process is carried in a first terminal management message sent by an STA. As shown in FIG. 4, the STA 1 is taken as an example, and the process of establishing a wireless initial connection starts from sending of a first management polling frame to completion of the wireless initial connection.

In a practical application process, in a network, such a situation may exist: an AP/STA that supports the method provided in the embodiment of the present invention coexists with an AP/STA that does not support the method provided in the embodiment of the present invention. To realize system compatibility, a terminal management message sent by an STA that supports the method provided in the embodiment of the present invention carries identification information, and an access point management message sent by an AP that supports the method provided in the embodiment of the present invention carries identification information, where the identification information is used to indicate that a message sending party supports the method provided in the embodiment of the present invention.

Accordingly, when an STA that supports the method provided in the embodiment of the present invention (hereinafter referred to as “new STA”) exchanges a wireless network management message with an AP that does not support the method provided in the embodiment of the present invention (hereinafter referred to as “old AP”): after receiving a terminal management message sent by the new STA, the old AP cannot parse identification information carried in the terminal management message, and then the terminal management message returned by the old AP to the new STA does not carry contention-free instruction information, and the new STA sends a next terminal management message in a contention period and exchanges a wireless network management message according to an existing method. When an STA that does not support the method provided in the embodiment of the present invention (hereinafter referred to as “old STA”) exchanges a wireless network management message with an AP that supports the method provided in the embodiment of the present invention (hereinafter referred to as “new AP”): the old STA receives an access point management message sent by the new AP, but cannot parse identification information carried in the access point management message, then directly discards the identification information, and sends a next terminal management message in a contention period; and the new AP receives a terminal management message sent by the old STA, and because the terminal management message does not carry identification information, the access point management message returned by the new AP to the old STA does not carry contention-free instruction information.

All or a part of the steps of the foregoing method embodiments may be implemented by a program instructing relevant hardware. The foregoing program may be stored in a computer readable storage medium. When the program is run, the steps of the foregoing method embodiments are performed. The foregoing storage medium may be any medium capable of storing program codes, such as a read-only memory (ROM), a random-access memory (RAM), a magnetic disk, or an optical disk.

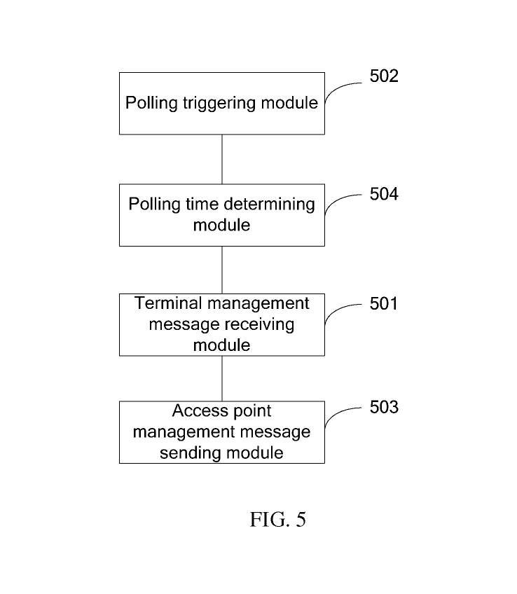

An embodiment of the present invention further provides an access point device whose structure is shown in FIG. 5. A detailed implementation structure is as follows: a terminal management message receiving module 501 configured to receive a first terminal management message sent by a terminal, where in a process that the terminal accesses a network, the terminal management message is a network accessing message sent by the terminal to the access point device; after the terminal accesses the network, when the terminal exchanges with the access point device to implement a certain function (for example, updating a key), the terminal management message refers to a series of service requesting messages sent by the terminal to the access point device to implement the function; and a polling triggering module 502 configured to send a management polling frame to the terminal in a contention-free period, so that the terminal sends a second terminal management message according to the management polling frame, where the management polling frame is a type of management frame, and is used to perform polling on the terminal in a process that the access point device exchanges a management message with the terminal, so as to trigger the terminal to send a next terminal management message.

The access point device provided in the embodiment of the present invention sends a management polling frame to a terminal, so as to control the terminal to send a terminal management message in a contention-free period. Therefore, a problem of a conflict among a plurality of terminals in a contention period is avoided, thereby decreasing time for exchanging a management message. In addition, a wireless network management message is sent in a contention-free period, thereby increasing a utilization rate of a channel.

The access point device provided in the embodiment of the present invention may further include an access point management message sending module 503 configured to return an access point management message to the terminal after the terminal management message receiving module 501 receives the terminal management message, where the access point management message carries contention-free instruction information and the contention-free instruction information is used for instructing the terminal to receive the management polling frame in the contention-free period.

The access point management message refers to a response message that corresponds to the terminal management message and is returned by the access point device to the terminal.

The access point device provided in the embodiment of the present invention may further include a polling time determining module 504 configured to determine polling time for the terminal according to information about quality of service carried in the first terminal management message.

The access point device provided in the embodiment of the present invention applies to a wireless communications network, and especially may apply to a Wi-Fi network.

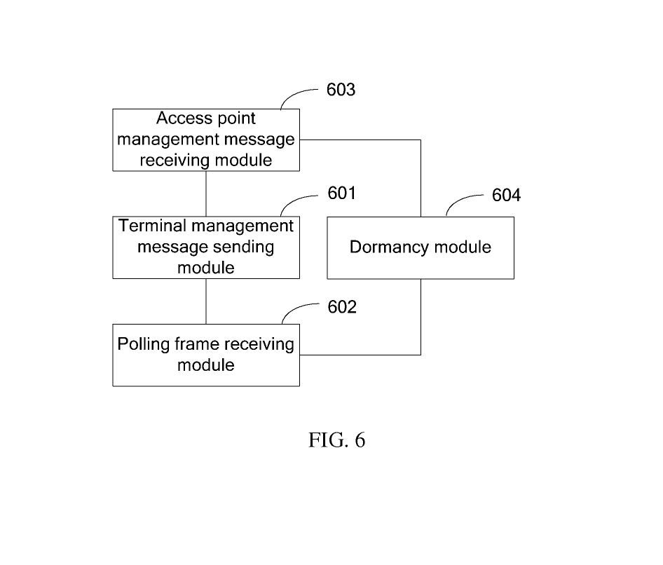

An embodiment of the present invention further provides a terminal whose structure is shown in FIG. 6. A detailed implementation structure is as follows: a terminal management message sending module 601 configured to send a first terminal management message to an access point device; and a polling frame receiving module 602 configured to receive, in a contention-free period, a management polling frame sent by the access point device.

The terminal management message sending module 601 is further configured to send a second terminal management message to the access point device after the polling frame receiving module 602 receives the management polling frame.

The terminal provided in the embodiment of the present invention may further include an access point management message receiving module 603 configured to receive an access point management message returned by the access point device, where the access point management message carries contention-free instruction information, so that the polling frame receiving module 602 receives the management polling frame in the contention-free period according to an instruction of the contention-free instruction information.

In the terminal provided in the embodiment of the present invention, the polling frame receiving module 602 is specifically configured to receive, at a moment of a contention-free period specified by polling time information, the management polling frame sent by the access point device, where the polling time information is included in the contention-free instruction information.

In an embodiment, the terminal may further include: a dormancy module 604 configured to enable the terminal to enter a dormant state, after the access point management message receiving module 603 receives the access point management message and before the contention-free period specified by the polling time information arrives.

The terminal provided in the embodiment of the present invention may send a terminal management message in a contention-free period according to a management polling frame sent by an access point device. Therefore, a problem of a conflict among a plurality of terminals in a contention period is avoided, thereby decreasing time for exchanging a management message. In addition, a wireless network management message is sent in a contention-free period, thereby increasing a utilization rate of a channel.

The terminal provided in the embodiment of the present invention applies to a wireless communications network, and especially, may apply to a Wi-Fi network.

The foregoing descriptions are only exemplary specific embodiments of the present invention, but are not intended to limit the protection scope of the present invention. Any variation or replacement easily figured out by persons skilled in the art within the technical scope disclosed in the present invention shall all fall within the protection scope of the present invention. Therefore, the protection scope of the present invention shall be subject to the protection scope of the claims.

What is claimed is:

1. A method for exchanging a wireless network management message, comprising:
receiving a first terminal management message sent by a terminal; and
sending a management polling frame to the terminal in a contention-free period such that the terminal sends a second terminal management message according to the management polling frame.

2. The method according to claim 1, wherein after receiving the first terminal management message sent by the terminal and before sending the management polling frame to the terminal, the method further comprises sending an access point management message to the terminal, wherein the access point management message carries contention-free instruction information, and wherein the contention-free instruction information is used for instructing the terminal to receive the management polling frame in the contention-free period.

3. The method according to claim 2, wherein the contention-free instruction information comprises polling time information such that the terminal waits for receiving a management polling frame at a moment of a contention-free period specified by the polling time information.

4. The method according to claim 2, wherein the terminal management message carries information about quality of service, and wherein before sending the access point management message to the terminal, the method further comprises determining polling time for the terminal according to the information about quality of service carried by the terminal management message.

5. The method according to claim 1, wherein the terminal management message comprises:
a network accessing message sent in a process that the terminal accesses a network; or
a service requesting message sent by the terminal to implement a preset function.

6. The method according to claim 1, wherein the method applies to a wireless fidelity (Wi-Fi) network.

7. A method for exchanging a wireless network management message, comprising:
sending a first terminal management message to an access point device;
receiving, in a contention-free period, a management polling frame sent by the access point device; and
sending a second terminal management message to the access point device after receiving the management polling frame.

8. The method according to claim 7, wherein after sending the first terminal management message to the access point device and before receiving the management polling frame sent by the access point device, the method further comprises receiving an access point management message returned by the access point device, wherein the access point management message carries contention-free instruction information such that the management polling frame is received in the contention-free period according to an instruction of the contention-free instruction information.

9. The method according to claim 8, wherein the contention-free instruction information comprises polling time information, and wherein receiving the management polling frame sent by the access point device specifically comprises receiving, at a moment of a contention-free period specified by the polling time information and according to the instruction of the contention-free instruction information, the management polling frame sent by the access point device.

10. The method according to claim 7, wherein sending the second terminal management message to the access point device after receiving the management polling frame comprises:
in the contention-free period, sending a second terminal management message to the access point device when the management polling frame sent by the access point device is received; and
sending the second terminal management message in a next contention period when the management polling frame is not received.

11. The method according to claim 7, wherein the terminal management message comprises:
a network accessing message sent in a process that the terminal accesses a network; or
a service requesting message sent by the terminal to implement a preset function.

12. The method according to claim 8, wherein after the access point management message is received and before the management polling frame is received, the method further comprises entering a dormant state.

13. The method according to claim 7, wherein the method applies to a wireless fidelity (Wi-Fi) network.

14. An access point device, comprising:
a terminal management message receiving module configured to receive a first terminal management message sent by a terminal; and
a polling triggering module configured to send a management polling frame to the terminal in a contention-free period such that the terminal sends a second terminal management message according to the management polling frame.

15. The access point device according to claim 14, wherein the access point device further comprises an access point management message sending module configured to return an access point management message to the terminal after the terminal management message receiving module receives the terminal management message, wherein the access point management message carries contention-free instruction information and the contention-free instruction information is used for instructing the terminal to receive the management polling frame in the contention-free period.

16. The access point device according to claim 15, wherein the access point device further comprises a polling time determining module configured to determine polling time for the terminal according to information about quality of service carried by the first terminal management message.

17. The access point device according to claim 14, wherein the access point device is an access point in a wireless fidelity (Wi-Fi) network.

18. A terminal, comprising:
a terminal management message sending module configured to send a first terminal management message to an access point device; and
a polling frame receiving module configured to receive, in a contention-free period, a management polling frame sent by the access point device,
wherein the terminal management message sending module is further configured to send a second terminal management message to the access point device after the polling frame receiving module receives the management polling frame.

19. The terminal according to claim 18, wherein the terminal further comprises an access point management message receiving module configured to receive an access point management message returned by the access point device, wherein the access point management message carries contention-free instruction information such that the polling frame receiving module receives the management polling frame in the contention-free period according to an instruction of the contention-free instruction information.

20. The terminal according to claim 19, wherein the polling frame receiving module is specifically configured to receive, at a moment of a contention-free period specified by polling time information, the management polling frame sent by the access point device, wherein the polling time information is comprised in the contention-free instruction information.

21. The terminal according to claim 20, further comprising a dormancy module configured to enable the terminal to enter a dormant state after the access point management message receiving module receives the access point management message and before the contention-free period specified by the polling time information arrives.

22. The terminal according to claim 18, wherein the terminal is a site device station (STA) in a wireless fidelity (Wi-Fi) network.
